(19) United States
(12) Patent Application Publication
(10) Pub. No.: US 2012/0214376 A1
(43) Pub. Date: Aug. 23, 2012

(54) GYPSUM BOARD AND METHOD FOR BONDING OUTER LAYERS TO CORE MATERIAL OF GYPSUM BOARD

(76) Inventor: BO-YI HOU, TAIPEI CITY (TW)

(21) Appl. No.: 13/031,288

(22) Filed: Feb. 21, 2011

(51) Int. Cl. B32B 13/12; B32B 13/14; B32B 37/00

(52) U.S. Cl. 442/386; 156/45; 428/703; 428/522

(57) ABSTRACT

A method includes outputting a semi-product of a core material for a gypsum board from a mixing tank. High-molecular adhesive is coated on inner faces of first and second outer layers that are bonded to two sides of the semi-product with the inner faces of the first and second outer layers engaged with the sides of the semi-product of the core material. After taking shape, the semi-product is severed and dried to obtain the core material for the gypsum board with the high-molecular adhesive forming high-molecular bonding layers between the core material and the first and second outer layers. The resultant gypsum board includes a core material and first and second outer layers securely bonded to two sides of the core material by high-molecular bonding layers formed by the high-molecular adhesive. Thus, the first and second outer layers are less likely to peel from the core material.

### BACKGROUND OF THE INVENTION

The present invention relates to a gypsum board and a method for making the gypsum board and, more particularly, to a method for bonding first and second outer layers to two sides of a core material for a gypsum board.

Gypsum boards contain a large amount of crystal water that can be released for putting out fire. Furthermore, gypsum boards provide good sound-proof effect while having toughness to provide anti-seismic effect. Further, gypsum boards allow fast work and are cheap. Thus, gypsum boards are commonly used in architecture.

FIG. 1 shows a conventional method for making gypsum boards. Primary materials 31 are added into a mixing tank 33. Raw materials 311 of the primary materials 31 include natural gypsum, gypsum obtained by flue gas desulphurization, recycled gypsum, or combinations thereof. The raw materials 311 are dried (see 312), ground (see 313), and calcined (see 314) to form hemihydrate gypsum. The hemihydrate gypsum is pulverized (see 315) and stored (see 316). Secondary materials 32 are added into the mixing tank 33 to mix with the primary materials 31. The secondary materials 32 include water 321, a curing agent 322, a foaming liquid 323, a water reducing agent 324, and additives 325 that may be required in special procedures. Starch 326 is also added into the mixing tank 33 to obtain a semi-product of a pasted core material (paste-like substance before completely dried). First and second outer layers 34 and 35 are bonded to two sides of the core material. Final products are obtained after taking shape (see 36), severing (see 37), drying (see 38), and cutting (see 39). The starch 326 providing the semi-product with tackiness is a polysaccharide consisting of a large number of glucose units. However, the tackiness is decided by the particular shape of the starch 326 that are affected by the types, producing areas, topography, and climate. Thus, the first and second outer layers 34 and 35 may peel from the dried product if the bonding is insecure.

Thus, a need exists for a novel method for making gypsum boards without the risk of peeling.

### BRIEF SUMMARY OF THE INVENTION

The present invention provides, in a first aspect, a method for bonding outer layers to a core material for a gypsum board including outputting a semi-product of the core material for a gypsum board from a mixing tank. High-molecular adhesive is coated on inner faces of first and second outer layers. The first and second outer layers are bonded to two sides of the semi-product of the core material with the inner faces of the first and second outer layers engaged with the two sides of the semi-product of the core material. After taking shape, the semi-product is severed and dried to obtain the core material for the gypsum board with the high-molecular adhesive forming a first high-molecular bonding layer between one of the two sides of the core material and the first outer layer and forming a second high-molecular bonding layer between the other of the two sides of the core material and the second outer layer.

In a second aspect, the present invention provides a gypsum board including a core material having two sides. First and second outer layers are bonded to the two sides of the core material. A first high-molecular bonding layer is provided between one of the two sides of the core material and the first outer layer. A second high-molecular bonding layer is provided between the other of the two sides of the core material and the second outer layer.

Preferably, the high-molecular bonding agent is a water-soluble resin.

Preferably, the water-soluble resin is selected from a group consisting of ethylene-vinyl acetate, polyvinyl acetate, or combinations thereof.

Preferably, the first and second outer layers are nonwoven.

The present invention will become clearer in light of the following detailed description of illustrative embodiments of this invention described in connection with the drawings.

### DESCRIPTION OF THE DRAWINGS

FIG. 1 shows a schematic view illustrating a conventional method for making gypsum boards.

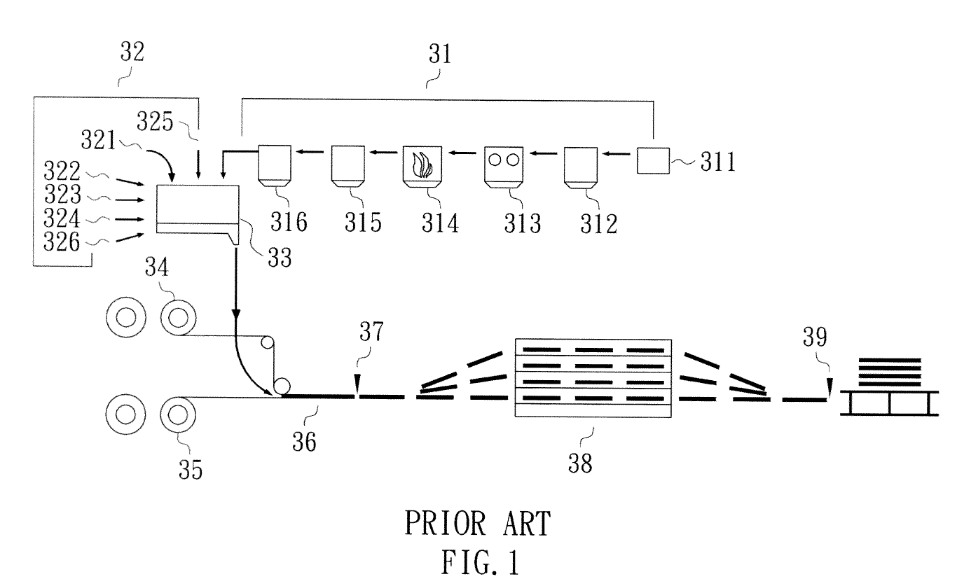

FIG. 2 shows a schematic view illustrating a method for making gypsum methods according to the present invention.

FIG. 3 shows a cross sectional view of a gypsum board according to the present invention.

### DETAILED DESCRIPTION OF THE INVENTION

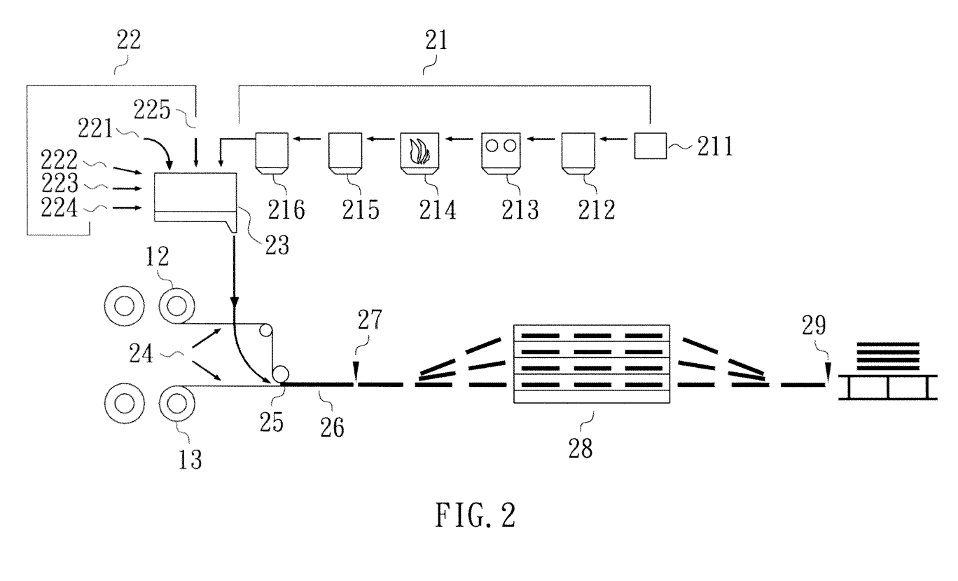

FIG. 2 shows a method for making gypsum boards according to the present invention. Primary materials 21 are added into a mixing tank 23. The raw materials 211 of the primary materials 21 include natural gypsum, gypsum obtained by flue gas desulphurization, recycled gypsum, or combinations thereof. Raw materials 211 are dried (see 212), ground (see 213), and calcined (see 214) to form hemihydrate gypsum. The hemihydrate gypsum is pulverized (see 215) and stored (see 216). Secondary materials 22 are added into the mixing tank 23 to mix with the primary materials 21. The secondary materials 22 include water 221, a curing agent 222, a foaming liquid 223, a water reducing agent 224, and additives 225 that may be required in special procedures, obtaining a semi-product 25 of a pasted core material (paste-like substance before completely dried).

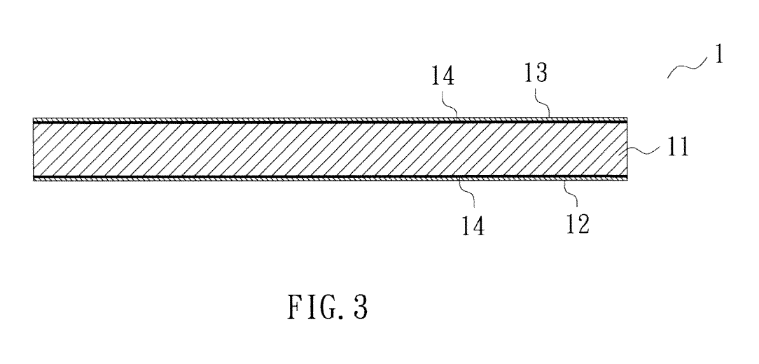

The method for bonding outer layers to a core material for a gypsum board includes outputting the semi-product 25 of the core material 1 for a gypsum board from the mixing tank 23. High-molecular adhesive 24 is coated on inner faces of first and second outer layers 12 and 13 and bonding the first and second outer layers 12 and 13 to two sides of the semi-product 25 of the core material 1 with the inner faces of the first and second outer layers 12 and 13 engaged with the two sides of the semi-product of the core material 1. Both of the first and second outer layers 12 and 13 can be nonwoven or lining paper for gypsum board. Alternatively, one of the first and second outer layers 12 and 13 is nonwoven, and the other of the first and second outer layers 12 and 13 is lining paper for gypsum board. After taking shape (see 26), severing (see 27), drying (see 28), and cutting (see 29), a core material 11 for a gypsum board 1 (FIG. 3) is obtained with the high-molecular adhesive 24 forming a first high-molecular bonding layer 14 between one of the two sides of the core material 11 and the first outer layer 12 and forming a second high-molecular bonding layer 14 between the other side of the core material 11 and the second outer layer 12. The first and second outer layers 12 and 13 are less likely to peel from the dried product having the high-molecular bonding layers 14.

Specifically, a high molecule (also known as polymer) is a substance having a massive molecular weight. A high molecule is a long-chain molecule consists of a large amount of monomers bonded by covalent bond. A high-molecular adhesive having a molecular weight up to thousands, dozens of thousands, or even hundreds of thousands of grams is a chemical substance capable of tightly bonding various materials together. Due to electromagnetic adsorption and chemical bonding between molecules and adjacent boundaries, the large, net-like molecule has certain cohesive force and, thus, has high bonding strength. No low-molecular materials are generated during curing. The molecules are arranged tightly due to hydrogen bonding therebetween and, thus, have a low shrinkage ratio and excellent reliability without the risk of deterioration. After curing, the high-molecular adhesive has a low water absorption ration and does not have active groups and ions, providing excellent water resistance. Furthermore, after curing, the high-molecular adhesive has strong cohesive force. The molecular structure is dense and has high mechanical strength. The high-molecular adhesive in the liquid state can moisten and permeate into the pores of inner faces of the first and second outer layers and 13 and the two sides of the core material 11. After curing, the high-molecular adhesive engages with the pores like anchors or hooks to provide bonding force.

Preferably, the high-molecular adhesive includes a water-soluble resin. No curing agent is required, allowing easy control while causing less pollution and providing safety.

Preferably, the water-soluble resin is selected from a group consisting of ethylene-vinyl acetate, polyvinyl acetate, or combinations thereof. By using ethylene-vinyl acetate and/or polyvinyl acetate as the adhesive, adhesive in the liquid state moistens the inner faces of the first and second outer layers 12 and 13 and the two sides of the core material 11 and permeates into the pores of the inner faces of the first and second outer layers 12 and 13 and the two sides of the core material 11. After curing, the adhesive 24 interlocks with the inner faces of the first and second outer layers 12 and 13 and the two sides of the core material 11 to provide bonding force. Furthermore, the alkyl and carboxyl in the bonding agent provides secondary bonding force by the hydrogen bond and polarity, enhancing the bonding strength. Thus, the gypsum board of the present invention possesses flexibility, water resistance, mildew resistance and can be used in moist areas for bonding tiles.

With reference to FIG. 3, the gypsum board 1 obtained from the method according to the present invention includes a core material 11 having two sides to which the first and second outer layers and 13 are bonded by high-molecular bonding layers 14. Each high-molecular bonding layer 14 includes ethylene-vinyl acetate and/or polyvinyl acetate. In the form shown, both of the first and second outer layers 12 and 13 are nonwoven. Nonwoven is permeable to air, soft, easy-to-cut, durable to folding, insulating, rainproof, leak-proof, tough, antibiotic, and sanitary.

Although specific embodiments have been illustrated and described, numerous modifications and variations are still possible without departing from the essence of the invention. The scope of the invention is limited by the accompanying claims.

1. A method for bonding outer layers to a core material for a gypsum board comprising:
outputting a semi-product of the core material for a gypsum board from a mixing tank;
coating high-molecular adhesive on inner faces of first and second outer layers and bonding the first and second outer layers to two sides of the semi-product of the core material with the inner faces of the first and second outer layers engaged with the two sides of the semi-product of the core material; and
severing and drying the semi-product after the semi-product taking shape, obtain the core material for the gypsum board with the high-molecular adhesive forming a first high-molecular bonding layer between one of the two sides of the core material and the first outer layer and forming a second high-molecular bonding layer between another of the two sides of the core material and the second outer layer.

2. The method as claimed in claim 1, wherein the high-molecular bonding agent is a water-soluble resin.

3. The method as claimed in claim 1, wherein the water-soluble resin is selected from a group consisting of ethylene-vinyl acetate, polyvinyl acetate, or combinations thereof.

4. The method as claimed in claim 1, wherein the first and second outer layers are nonwoven.

5. A gypsum board comprising a core material having two sides, with first and second outer layers bonded to the two sides of the core material, with a first high-molecular bonding layer provided between one of the two sides of the core material and the first outer layer, with a second high-molecular bonding layer provided between another of the two sides of the core material and the second outer layer.

6. The gypsum board as claimed in claim 5, wherein the high-molecular bonding layer is formed by a water-soluble resin.

7. The gypsum board as claimed in claim 1, wherein the water-soluble resin is selected from a group consisting of ethylene-vinyl acetate, polyvinyl acetate, or combinations thereof.

8. The gypsum board as claimed in claim 1, wherein the first and second outer layers are nonwoven.
